(19) United States
(12) Patent Application Publication
(10) Pub. No.: US 2012/0031038 A1
(43) Pub. Date: Feb. 9, 2012

(54) CELLULAR PANEL

(75) Inventors: Bertrand Desjoyeaux, Sainte Adresse (FR); John Moutier, Le Havre (FR)

(73) Assignee: AIRCELLE, Gonfreville l'Orcher (FR)

(21) Appl. No.: 13/264,808

(22) PCT Filed: Mar. 18, 2010
(86) PCT No.: PCT/FR10/50486

§ 371 Date: Oct. 17, 2011

(30) Foreign Application Priority Data
Apr. 16, 2009 (FR) 0952486

(51) Int. Cl. E04C 2/40; B23P 17/04

(52) U.S. Cl. 52/782.1; 29/428

(57) ABSTRACT

The present invention relates to a cellular panel deployable from a compacted form to a deployed form, including, in the compacted form thereof, a plurality of consecutive sheets substantially parallel to one another and substantially perpendicular to an expansion direction, each sheet being discretely joined at a plurality of junction points with the following and/or preceding sheet, the junction points being substantially regularly spaced apart along the lines substantially parallel to the sheets and alternating with the preceding and/or following junction points, characterized in that, on at least one line parallel to the expansion direction, one or more junction points are excised or are not made and the portions of the sheets associated with said excised or unmade junction points are excised.

### TECHNICAL FIELD

The present invention relates to a method for manufacturing a panel having a cellular structure of the honeycomb type.

### BACKGROUND

Airplane turbojet engines create substantial noise pollution. There is a high demand to reduce this pollution, even more so given that the turbojet engines used are becoming increasingly powerful. The design of the nacelle surrounding the turbojet engine contributes in large part to reducing this noise pollution.

In order to further improve the acoustic performance of aircrafts, the nacelles are provided with acoustic panels aiming to attenuate the noises due to the circulation of air streams through the turbojet engine as well as the vibrations of the structures of the nacelle.

The acoustic panels are sandwich-type structures that are well known for absorbing these noises. These panels generally have one or more layers with a cellular structure (commonly called honeycomb or honeycomb cores). These layers are then covered on a so-called outer face (opposite the source of the noise) with an air-impermeable solid skin and on an inner face (facing the noise source) with a so-called acoustic perforated skin.

A cellular core panel is generally obtained first by superimposing several sheets of metal, light alloy, composite material or another suitable material, on which adhesion means are placed in staggered rows to cause adjacent sheets to adhere to each other at certain points called junction points.

A cellular panel then forms in a compact form, i.e. the sheets are assembled together locally (by adhesion, welding, or other technique) without the cells being formed.

The cells are formed during an expansion phase of the compacted panel aiming to space the sheets apart from each other, the latter remaining attached, however, at the junction points, thereby creating the cells. The cells thus created are generally of the hexagonal or elliptical type.

One of the problems is that the expansion of the compact panel is generally uniform and leads to cellular panels in developable shapes with parallel generatrices, such as a substantially rectangular panel, for example.

Thus, when one wishes to equip a complex surface with an acoustic covering, it is necessary to attach several panels to each other and/or cut them out into suitable shapes.

This results in increasing the mass of the acoustic covering (material used to attach the panels) as well as decreasing the acoustic performance due to the loss of cells (covering of orifices of the perforated skin or of cells by the joining material or by cutting out the panels).

As a result, there is a need for a method of manufacturing a cellular core panel allowing a nonlinear expansion of said panel according to a complex non-developable shape (barrel shape, for example) or a developable shape with non-parallel surface generatrices (cone, for example).

It will also be noted that the attachment of several cellular panels causes considerable clippings. There is therefore also a need to reduce the amount of lost material.

Of course, the problem is not limited to acoustic panels and generally concerns all cellular-core panels.

### BRIEF SUMMARY

To that end, the present invention relates to a cellular panel deployable from a compacted form to a deployed form, including, in the compacted form thereof, a plurality of consecutive sheets substantially parallel to one another and substantially perpendicular to an expansion direction, each sheet being discretely joined at a plurality of junction points with the following and/or preceding sheet, the junction points being substantially regularly spaced apart along the lines substantially parallel to the sheets and alternating with the preceding and/or following junction points, characterized in that, on at least one line parallel to the expansion direction, one or more junction points are excised or are not made and the portions of the sheets associated with said excised or unmade junction points are excised.

Thus, by excising the junction points and the associated portions of the sheets, it is possible to locally rearrange the cellular distribution of the panel and in particular to group cells together to reduce the number thereof along a given expansion line.

By reducing the number of cells, it is possible to obtain different expansion widths for the panel along the sheets. As a result, the expansion will no longer be uniform, but will make it possible to obtain width regressivity of the panel depending on the desired structure and shape.

A panel according to the invention can thus be adapted to the desired shape without requiring the cutting out and junction of several panels. This results in mass gains and optimization of the number of effective cells.

Advantageously, at an excision area of the junction points, at least two sheets that are not initially consecutive are connected to each other by at least one junction point after excision of part of the intermediate sheets at said junction point.

According to a first alternative embodiment, the panel comprises at least one excision aiming to group together two cells to form a single cell.

According to a second alternative embodiment, possibly complementary, the panel comprises at least one excision aiming to group together three cells to form a single cell.

Preferably, the excisions and any new junctions are made so that the panel has different expansion lengths in a direction perpendicular to the expansion direction.

Advantageously, the excisions and new junctions are done so that after expansion, the cellular panel has a trapezoidal shape. Also advantageously, the cellular panel has a shape allowing the formation of a cone by closing the panel on itself. Other shapes are of course possible.

According to one design alternative, at least one sheet is formed from a plurality of foils connected to each other.

The present invention also relates to a method of manufacturing a deployable cellular panel according to the invention, comprising, in a compacted form, a plurality of consecutive sheets substantially parallel to each other and substantially perpendicular to an expansion direction, each sheet being discretely joined at a plurality of junction points with the following and/or preceding sheet, the junction points being substantially regularly spaced apart along the lines substantially parallel to the sheets and alternating with the preceding and/or following junction points, characterized in that said method comprises the steps aiming to:

on at least one line parallel to the expansion direction, excise or not make one or more junction points as well as the portions of the sheets associated with said excised or unmade junction points.

### BRIEF DESCRIPTION OF THE DRAWINGS

The present invention will be better understood in light of the following detailed description, done in reference to the appended drawing, in which:

FIG. 1 is a view of a cellular panel of the prior art in its compacted form.

FIG. 2 is a partial enlarged view of the compacted panel of FIG. 1.

FIG. 3 is a view of the panel of FIG. 1 after expansion.

FIG. 4 is the equivalent of FIG. 2 after expansion of the panel.

FIG. 5 is a diagrammatic illustration of a cellular panel according to the invention and after expansion of said panel.

FIG. 6 is a partial enlarged view of the panel of FIG. 5.

FIG. 7 is a partial enlarged view of the panel of FIG. 5 in compacted form.

FIGS. 8 and 9 are alternatives of the result of FIG. 7 after expansion.

FIG. 10 is a partial enlarged view of the panel of FIG. 5 in compacted form.

FIG. 11 is a view of the panel of FIG. 10 after expansion.

FIG. 12 shows several alternatives of cell junctions and modifications.

### DETAILED DESCRIPTION

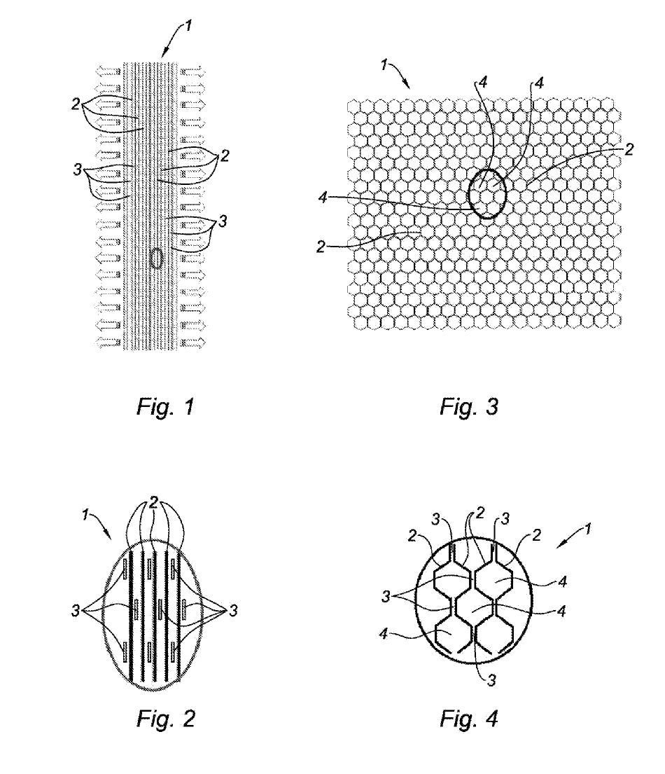

FIGS. 1 to 4 show a deployable cellular panel 1 made according to the prior art.

In its compacted form, as shown in FIGS. 1 and 2, such a panel 1 comprises a plurality of adjacent sheets 2 arranged substantially parallel to each other.

Each sheet 2 is discretely joined in a plurality of junction points 3 with the following and/or preceding sheet 2, the junction points 3 being spaced apart substantially regularly along lines substantially parallel to the sheets 2 and alternating with the preceding and/or following junction points 2.

Thus, when the cellular panel 1 is unfolded in an expansion direction (arrow of FIG. 1), the non-joined portions of the sheets 2 move apart while the joined segments remain integral. The formation of cells 4 as shown in FIGS. 3 and 4 follows. The walls forming the cells are called foils.

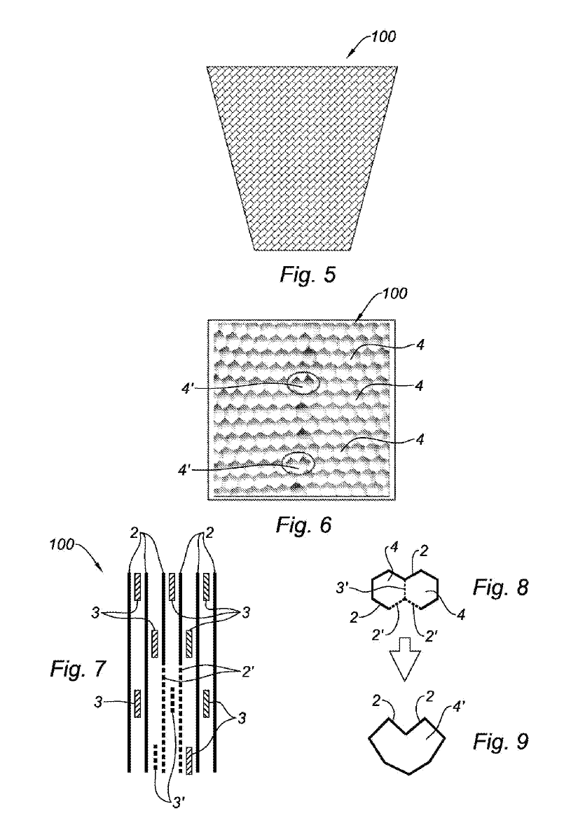

The present invention aims to enable the manufacture of a cellular panel 100 having non-constant expansion lengths along the panel 100 so as to be able to obtain a complex or non-developable surface after deployment. One example of such a cellular panel 100 after deployment is shown in FIG. 5.

The variation of the expansion length of the cellular panel 100 on an expansion line is obtained by varying the lengths of the foils, in particular by excising and locally grouping together cells 4.

FIG. 5 shows such cells 4′ obtained from two cells 4.

FIGS. 7 to 9 show one example of obtainment of such cells 4′.

To group cells 4 together locally from a cellular panel 1 in compacted form, one locally eliminates the production of certain junction points 3′ (broken lines) as well as corresponding portions 2′ (broken lines) of the sheets 2.

FIG. 8 shows the portions eliminated in the case relative to an expansion and traditional cells 4 (broken lines).

After excision of the junction points 3′ and the portions of the sheets 2′, the remaining junction points 3 are connected to the adjacent sheet 2 after said excision so as to reform the cell.

The obtained call 4′ is shown in FIG. 9. The length of the foils of the cell 4′ is reduced as a result, which will cause a reduction in the expansion length on the line of said cell 4′.

The positioning of several reductions locally will make it possible to obtain a cellular panel 100 with the desired shape.

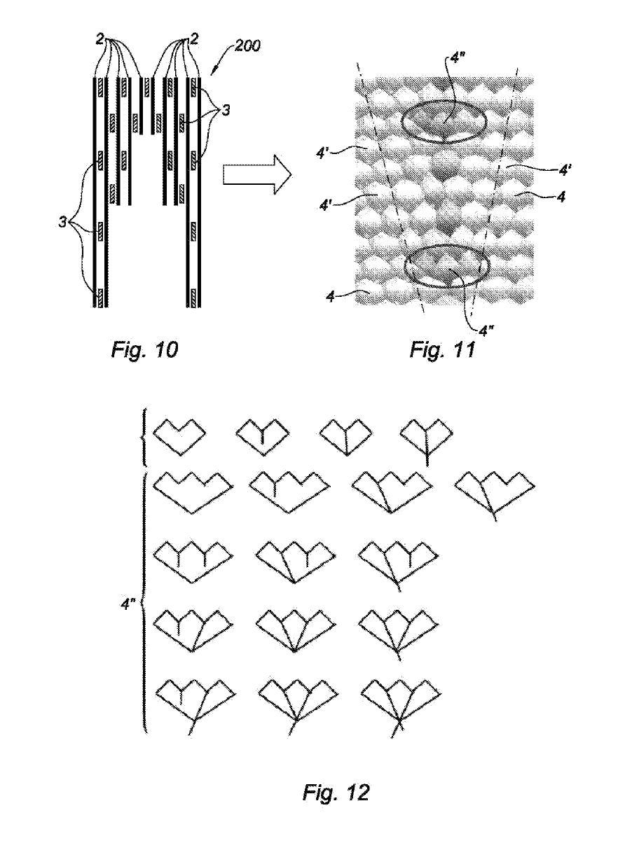

FIGS. 10 to 12 show alternatives of grouping together three cells 4 to form a cell 4″ in a cellular panel 200.

FIG. 12 shows different possibilities of cells 4″ that can each be formed by grouping together three cells 4, as a function of the relative positions of the cut-outs and the foils, as well as the positions of the junction points 3.

Of course, the number of cells one can group together is not limited.

It will be noted that the invention is applicable to other cellular panels obtained from foils, in particular zigzag foils that are assembled unitarily to each nodal joint. The present invention is also applicable for corrugated foils (so-called “Flex Core” honeycombs).

The invention may also be applied to cell shapes other than a regular hexagon, once the walls of the cells are obtained by assemblies through juxtaposition and connection of foils.

It will in particular be noted that the periodic reduction of the expansion length along a generatrix of the panel (direction perpendicular to the expansion direction of the panel and more generally substantially parallel to the direction of the sheets 2) makes it possible to generate, on either side of said generatrix, two primary longitudinal directions that impart anisotropic mechanical properties to the panel.

More generally, the periodic dispersion of the reductions of foils makes it possible to produce a panel that, upon expansion and forming, can adapt to a shape, e.g. conical, while offering the longitudinal direction of the foils substantially parallel everywhere to the generatrices of the cone up to 360° of revolution.

By positioning the variations of the number of foils differently, the panel may be adapted to different non-developable and more or less of-revolution surfaces, such as barrel or barrel-shaped forms, for example.

Although the invention has been described with one particular embodiment, it is of course in no way limited thereto and encompasses all technical equivalents of the described means as well as combinations thereof if they are within the scope of the invention.

1. A cellular panel deployable from a compacted form to a deployed form, including, in the compacted form thereof, a plurality of consecutive sheets substantially parallel to one another and substantially perpendicular to an expansion direction, each sheet being discretely joined at a plurality of junction points with the following and/or preceding sheet, the junction points being substantially regularly spaced apart along lines substantially parallel to the sheets and alternating with the preceding and/or following junction points, wherein, on at least one line parallel to the expansion direction, one or more junction points are excised or are not made and portions of the sheets associated with said excised or unmade junction points are excised.

2. The cellular panel according to claim 1, wherein at an excision area of the junction points, at least two sheets that are not initially consecutive are connected to each other by at least one junction point after excision of part of the intermediate sheets at said junction point.

3. The cellular panel according to claim 1, wherein the panel comprises at least one excision aiming to group together two cells to form a single cell.

4. The cellular panel according to claim 1, wherein the panel comprises at least one excision aiming to group together three cells to form a single cell.

5. The cellular panel according to claim 1, wherein the excisions and any new junctions are made so that the panel has different expansion lengths in a direction perpendicular to the expansion direction.

6. The cellular panel according to claim 5, wherein the excisions and new junctions are done so that after expansion, the cellular panel has a trapezoidal shape.

7. The cellular panel according to claim 5, wherein the excisions and new junctions are done so that after expansion, the cellular panel has a shape allowing the formation of a cone by closing the panel on itself.

8. The cellular panel according to claim 1, wherein at least one sheet is formed from a plurality of foils connected to each other.

9. A method of manufacturing a deployable cellular panel according to claim 1, comprising, in a compacted form, a plurality of successive sheets substantially parallel to each other and substantially perpendicular to an expansion direction, each sheet being discretely joined at a plurality of junction points with the following and/or preceding sheet, the junction points being substantially regularly spaced apart along lines substantially parallel to the sheets and alternating with the preceding and/or following junction points, wherein said method comprises the steps aiming to:
on at least one line parallel to the expansion direction, excise or not make one or more junction points as well as the portions of the sheets associated with said excised or unmade junction points.
